(19) United States
(12) Patent Application Publication
(10) Pub. No.: US 2019/0093570 A1
(43) Pub. Date: Mar. 28, 2019

(54) COMBUSTION DEVICE AND GAS TURBINE

(71) Applicant: MITSUBISHI HEAVY INDUSTRIES, LTD., Tokyo (JP)

(72) Inventors: Kenji MIYAMOTO, Tokyo (JP); Kei INOUE, Kanagawa (JP); Shin KATO, Kanagawa (JP); Tomo KAWAKAMI, Kanagawa (JP)

(21) Appl. No.: 16/080,877

(22) PCT Filed: Feb. 24, 2017
(86) PCT No.: PCT/JP2017/007026

§ 371 Date: Aug. 29, 2018

(30) Foreign Application Priority Data
Mar. 3, 2016 (JP) 2016-040951

(51) Int. Cl. F02C 9/40; F23R 3/14; F23R 3/36; F02C 9/32; F02C 7/224; F02C 7/232

(52) U.S. Cl. CPC F02C 9/40; F23R 3/14; F23R 3/36; F05D 2270/20; F02C 7/224; F02C 7/232; F05D 2240/35; F02C 9/32

(57) ABSTRACT

A combustion device includes: a nozzle casing defining an axial flow passage; and a nozzle disposed in the axial flow passage. The nozzle includes: a nozzle body having a tubular shape extending along the axial flow passage; a swirler vane protruding radially outward from the nozzle body in a radial direction of the nozzle body; at least one first injection hole having an opening on a surface of the nozzle body or the swirler vane; at least one second injection hole having an opening on the surface of the nozzle body or the swirler vane; a first fuel flow passage extending through the nozzle body and being in communication with the at least one first injection hole; and a second fuel flow passage extending through the nozzle body separately from the first fuel flow passage, and being in communication with the at least one second injection hole.

### TECHNICAL FIELD

The present disclosure relates to a combustion device and a gas turbine.

### BACKGROUND ART

In a combustion device used in a gas turbine or the like, fuels having different characteristics may be combusted, depending on the operational condition or the like.

For instance, Patent Document 1 discloses a gas turbine combustor including a main fuel nozzle for injecting a fuel into a combustion chamber, a precombustion fuel nozzle for injecting a fuel into air before the air is introduced into the combustion chamber, and a flow-rate adjustment unit for adjusting the flow rate of the fuels to be supplied to the main fuel nozzle and the precombustion fuel nozzle. This gas turbine combustor is configured to supply an appropriate amount of fuel to the combustion chamber corresponding to the characteristics of the fuels, to combust the fuel stably. That is, the flow rate of the fuels to be supplied to the main fuel nozzle and the precombustion fuel nozzle is adjusted in accordance with the characteristics (e.g. heat generation amount) supplied to the main fuel nozzle and the precombustion fuel nozzle.

### CITATION LIST

### Patent Literature

Patent Document 1: JP2007-46843A

### SUMMARY

### Problems to be Solved

Meanwhile, fuels used to obtain a predetermined amount of combustion heat in a combustion device may include, for instance, a fuel containing a relatively large amount of inert components and having a relatively small calorific value (hereinafter, referred to as low-calorie fuel), and a fuel containing a relatively small amount of inert components and having a relatively large calorific value (hereinafter, referred to as high-calorie fuel).

When a low-calorie fuel is used, it is necessary for the fuel to have a relatively high flow velocity to obtain a supply amount (flow rate) required to obtain a predetermined amount of combustion heat. Thus, when a low-calorie fuel is used, it is necessary to increase the pipe diameter and the nozzle diameter relatively, to reduce pressure loss in the pipe or the like.

On the other hand, when a high-calorie fuel is used, it is necessary to reduce the flow velocity of the fuel, because a smaller fuel supply amount (flow rate) is required to obtain a similar amount of combustion heat to that in a case using the low-calorie fuel compared to the case using the low-calorie fuel. Thus, when the high-calorie fuel is to be applied to pipes and nozzles having a diameter suitable for the low-calorie fuel, the flow velocity of the fuel decreases compared to a case using the low-calorie fuel. Thus, the differential pressure across nozzles for injecting the fuel decreases, which may lead to generation of combustion vibration in the combustor (combustion device).

In view of the above, an object of at least one embodiment of the present invention is to provide a combustion device whereby the differential pressure before and after fuel injection can be easily maintained even when fuels having different characteristics are applied.

### Solution to the Problems

(1) According to at least one embodiment of the present invention, a combustion device includes: a nozzle casing defining an axial flow passage; and at least one nozzle disposed in the axial flow passage. The at least one nozzle includes: a nozzle body having a tubular shape extending along the axial flow passage; a swirler vane protruding radially outward from the nozzle body in a radial direction of the nozzle body, the swirler vane being configured to swirl a fluid flowing through the axial flow passage; at least one first injection hole having an opening on a surface of the nozzle body or the swirler vane; at least one second injection hole having an opening on the surface of the nozzle body or the swirler vane; a first fuel flow passage extending through the nozzle body and being in communication with the at least one first injection hole; and a second fuel flow passage extending through the nozzle body separately from the first fuel flow passage, and being in communication with the at least one second injection hole.

With the above configuration (1), the first fuel flow passage and the second fuel flow passage being in communication with the first injection holes and the second injection holes for injecting fuel, respectively, are provided separately. Thus, it is possible to design the first fuel flow passage and the first injection holes suitably according to the characteristics of the fuel that flows through the first fuel flow passage, and design the second fuel flow passage and the second injection holes suitably according to the characteristics of the fuel that flows through the second fuel flow passage.

(2) In some embodiments, in the above configuration (1), the first injection hole has a greater total area than the second injection hole.

With the above configuration (2), with the total area of the first injection holes (e.g. the total of the opening area or the total of the flow passage area) being greater than the total area of the second injection holes, a greater amount of fuel is injected from the first injection holes than from the second injection holes. Thus, in a case where fuel is injected from the first injection holes, the differential pressure across the first injection holes can be easily maintained. Furthermore, with the total area of the second injection holes being smaller than the total area of the first injection holes, the differential pressure across the second injection holes can be easily maintained, even though the flow rate of fuel injected from the second injection holes is relatively low. Thus, with the above configuration (2), the differential pressure before and after fuel injection can be easily maintained in the combustion device.

(3) In some embodiments, in the above configuration (2), the first fuel flow passage has a greater flow passage area than the second fuel flow passage.

With the above configuration (3), with the flow passage area of the first fuel flow passage being greater than the flow passage area of the second fuel flow passage, a greater amount of fuel is injected from the first injection holes than from the second injection holes. Thus, in a case where fuel is injected from the first injection holes, the differential pressure across the first injection holes can be easily maintained. Furthermore, with the flow passage area of the second fuel flow passage being smaller than the flow passage area of the first fuel flow passage, the differential pressure across the second injection holes can be easily maintained, even though the flow rate of fuel injected from the second injection holes is relatively low. Thus, with the above configuration (3), the differential pressure before and after fuel injection can be easily maintained in the combustion device.

(4) In some embodiments, in the above configuration (3), a ratio of a flow passage area ratio to an injection hole total area ratio (the flow passage area ratio/the injection hole total area ratio) is not lower than 0.8 and not higher than 1.2. The flow passage area ratio is a ratio of the flow passage area of the first fuel flow passage to the flow passage area of the second fuel flow passage. The injection hole total area ratio is a ratio of the total area of the first injection hole to the total area of the second injection hole.

With the above configuration (4), the ratio of the flow passage area ratio to the injection hole total area ratio is nearly one, and thus it is possible to reduce pressure loss in the first fuel flow passage and the second fuel flow passage, and thus the differential pressure before and after fuel injection can be easily maintained in the combustion device.

(5) In some embodiments, in any one of the above configurations (1) to (4), the first injection hole is disposed upstream of the second injection hole in a flow direction of the fluid in the axial flow passage.

The fuel injected from the first injection hole and the second injection hole is combusted after being mixed with air that flows from the upstream side of the axial flow passage. With the above configuration (5), since the first injection holes are disposed upstream of the second injection holes, for fuel injected from the first injection holes, it is possible to increase the mixing distance with air flowing from the upstream side through the axial flow passage, as much as the distance between the first injection holes and the second injection holes, compared to fuel injected from the second injection holes. Thus, it is possible to promote mixing (pre-mixing) of air and fuel injected from the first injection hole, and obtain a high combustion efficiency in the combustion device.

(6) In some embodiments, in any one of the above configurations (1) to (5), in the nozzle body or the swirler vane, the at least one first injection hole comprises at least two first injection holes or the at least one second injection hole comprises at least two second injection holes, and wherein the at least two first injection holes or the at least two second injection holes are disposed on different positions from one another in a radial direction of the nozzle body.

With the above configuration (6), the at least two first injection holes or second injection holes are disposed on different positions from one another in the radial direction of the nozzle body, and thus it is possible to smoothen the flow of fuel in the first fuel flow passage or the second fuel flow passage. Thus, it is possible to supply fuel smoothly from the first injection holes or the second fuel flow passage.

(7) In some embodiments, in the above configuration (6), of the at least two first injection holes or the at least two second injection holes, an outer injection hole disposed on an outer side in the radial direction is disposed upstream of an inner injection hole disposed on an inner side in the radial direction, with respect to a flow direction of the fluid in the axial flow passage.

In the axial flow passage, the air flows through a larger flow passage area on the radially outer side. Thus, with the above configuration (7), mixing of air and fuel injected from the outer injection hole disposed on the radially outer side in the axial flow passage is promoted further, and thus it is possible to achieve an even higher combustion efficiency.

(8) In some embodiments, in the above configuration (6) or (7), of the at least two first injection holes or the at least two second injection holes, an outer injection hole disposed on an outer side in the radial direction has a greater hole diameter than an inner injection hole disposed on an inner side in the radial direction.

With the above configuration (8), the flow rate of the fuel injected from the outer injection hole increases even further, and thus it is possible to inject a greater amount of fuel from the outer injection hole to promote mixing with air, which makes it possible to obtain a higher combustion efficiency.

(9) In some embodiments, in any one of the above configurations (1) to (8), the combustion device further includes: a first supply flow passage capable of supplying a first fuel to the first fuel flow passage; and a second supply flow passage capable of supplying a second fuel other than the first fuel to the second fuel flow passage. The first fuel has a smaller calorific value than the second fuel.

With the above configuration (9), the first fuel and the second fuel having different calorific values are supplied via different fuel flow passages and injection holes. Thus, the first fuel flow passage and the first fuel injection hole can be designed suitably according to the first fuel having a relatively small calorific value (low-calorie fuel), and the second fuel flow passage and the second injection hole can be designed suitably according to the second fuel having a relatively large calorific value (high-calorie fuel).

Further, in a case where the total area of the first injection holes is greater than the total area of the second injection holes, the flow rate of the first fuel (low-calorie fuel) injected from the first injection holes is relatively high, and the total area of the second injection holes is relatively small, and thus the differential pressure is likely to be maintained across the second injection holes for injecting the second fuel having a relatively low flow rate (high-calorie fuel). Thus, the differential pressure before and after fuel injection can be easily maintained in the combustion device.

Further, in a case where the first injection holes are disposed upstream of the second injection holes, for the first fuel (low-calorie fuel) having a relatively large flow rate injected from the first injection holes, it is possible to increase the mixing distance with air flowing from the upstream side through the axial flow passage, as much as the distance between the first injection holes and the second injection holes, compared to the second fuel (high-calorie fuel) having a relatively small flow rate injected from the second injection holes. Thus, it is possible to promote mixing (pre-mixing) of air and the first fuel (low-calorie fuel) having a relatively high flow rate injected from the first injection hole, and obtain a good combustion efficiency in the combustion device as a whole.

(10) In some embodiments, in the above configuration (9), a ratio of a total area of the first injection hole to a total area of the second injection hole is determined on the basis of a ratio of the calorific value of the first fuel to the calorific value of the second fuel.

With the above configuration (10), a ratio of the total area of the first injection holes to the total area of the second injection holes is determined in accordance with a ratio of the calorific value of the first fuel (low-calorie fuel) to the calorific value of the second fuel (high-calorie fuel). Accordingly, it is possible to reduce variation of combustion heat between the time using the first fuel (low-calorie fuel) and the time using the second fuel (high-calorie fuel), and thus it is possible to combust the fuel stably even in a case where the first fuel (low-calorie fuel) and the second fuel (high-calorie fuel) are used in turn.

(11) In some embodiments, in any one of the above configurations (1) to (8), the combustion device further includes a mixer capable of producing a mixed fuel by mixing a first fuel and a second fuel having different calorific values from each other; a first supply flow passage capable of supplying the mixed fuel to the first fuel flow passage; a second supply flow passage capable of supplying the mixed fuel to the second fuel flow passage; and a second valve which is disposed in the second supply flow passage, and which is configured to be capable of adjusting a flow rate of the mixed fuel to be supplied to the second fuel flow passage.

With the above configuration (11), a mixed fuel can be supplied to the first fuel flow passage and the second fuel flow passage, and the mixed fuel supplied to the second fuel flow passage can be adjusted by the second valve. Thus, by adjusting the flow rate of the mixed fuel in the second fuel flow passage with the second valve, it is possible to adjust the flow rate of the entire mixed fuel.

(12) In some embodiments, in the above configuration (11), the combustion device includes a heater capable of heating the mixed fuel produced by the mixer. The first supply flow passage is configured to supply the first fuel flow passage with the mixed fuel heated by the heater. The second supply flow passage is configured to supply the second fuel flow passage with the mixed fuel heated by the heater.

In the above configuration (12), the mixed fuel obtained by mixing the first fuel and the second fuel is supplied to the first fuel flow passage and the second fuel flow passage, and thus it is sufficient if the heater for heating the fuel is provided so as to heat the fuel after mixing. Thus, with the above configuration (12), it is possible to reduce the costs compared to a case where a heater is disposed separately for each of the first fuel and the second fuel.

(13) In some embodiments, in the above configuration (11) or (12), the second valve is configured such that an opening degree of the second valve is adjustable in accordance with a mixing ratio of the first fuel and the second fuel in the mixed fuel.

With the above configuration (13), the opening degree of the second valve is adjustable in accordance with the mixing ratio of the first fuel and the second fuel, and thus it is possible to adjust the flow rate of the entire mixed fuel suitably in accordance with the mixing ratio. For instance, if the mixed fuel contains a large amount of first fuel and has a relatively small calorific value, the opening degree of the second valve may be increased to obtain a high flow rate, thereby supplying the mixed fuel to both of the first fuel flow passage and the second fuel flow passage. Further, if the mixed fuel contains a large amount of second fuel and has a relatively large calorific value, the opening degree of the second valve may be reduced to obtain a relatively low flow rate, thereby supplying the mixed fuel mainly to the first fuel flow passage.

(14) A gas turbine according to at least one embodiment of the present invention includes: a compressor for producing compressed air; the combustion device according to any one of the above (1) to (13), configured to generate combustion gas by combusting a fuel injected from at least one of the at least one first fuel injection hole or the at least one second fuel injection hole, with the compressed air from the compressor; and a turbine configured to be driven by the combustion gas from the combustion device.

With the above configuration (14), the first fuel flow passage and the second fuel flow passage being in communication with the first injection holes and the second injection holes for injecting fuel, respectively, are provided separately. Thus, it is possible to design the first fuel flow passage and the first injection holes suitably according to the characteristics of the fuel that flows through the first fuel flow passage, and design the second fuel flow passage and the second injection holes according to the characteristics of the fuel that flows through the second fuel flow passage.

### Advantageous Effects

According to at least one embodiment of the present invention, it is possible to provide a combustion device whereby it is possible to reduce combustion vibration even when fuels having different characteristics are applied.

### BRIEF DESCRIPTION OF DRAWINGS

FIG. 1 is a schematic configuration diagram of a gas turbine according to an embodiment of the present invention.

FIG. 2 is a schematic diagram of a combustor (combustion device) according to an embodiment.

FIG. 3 is a cross-sectional view of a combustor (combustion device) according to an embodiment.

FIG. 4 is a cross-sectional view of a part of a combustor (combustion device) according to an embodiment.

FIG. 5 is a view taken in the direction of the arrow A of the combustor (combustion device) depicted in FIG. 4.

FIG. 6 is a partial cross-sectional view taken along the axial direction of a nozzle according to an embodiment.

FIG. 7 is a cross-sectional view taken along line VII-VII in FIG. 6.

FIG. 8 is a cross-sectional view taken along line VIII-VIII in FIG. 6.

FIG. 9 is a partial cross-sectional view taken along the axial direction of a nozzle according to an embodiment.

FIG. 10 is a cross-sectional view of the nozzle shown in FIG. 9, taken along line X-X.

FIG. 11 is a configuration diagram of a fuel supply system of combustor (combustion device) according to an embodiment.

FIG. 12 is a configuration diagram of a fuel supply system of combustor (combustion device) according to an embodiment.

### DETAILED DESCRIPTION

Embodiments of the present invention will now be described in detail with reference to the accompanying drawings. It is intended, however, that unless particularly identified, dimensions, materials, shapes, relative positions and the like of components described in the embodiments shall be interpreted as illustrative only and not intended to limit the scope of the present invention.

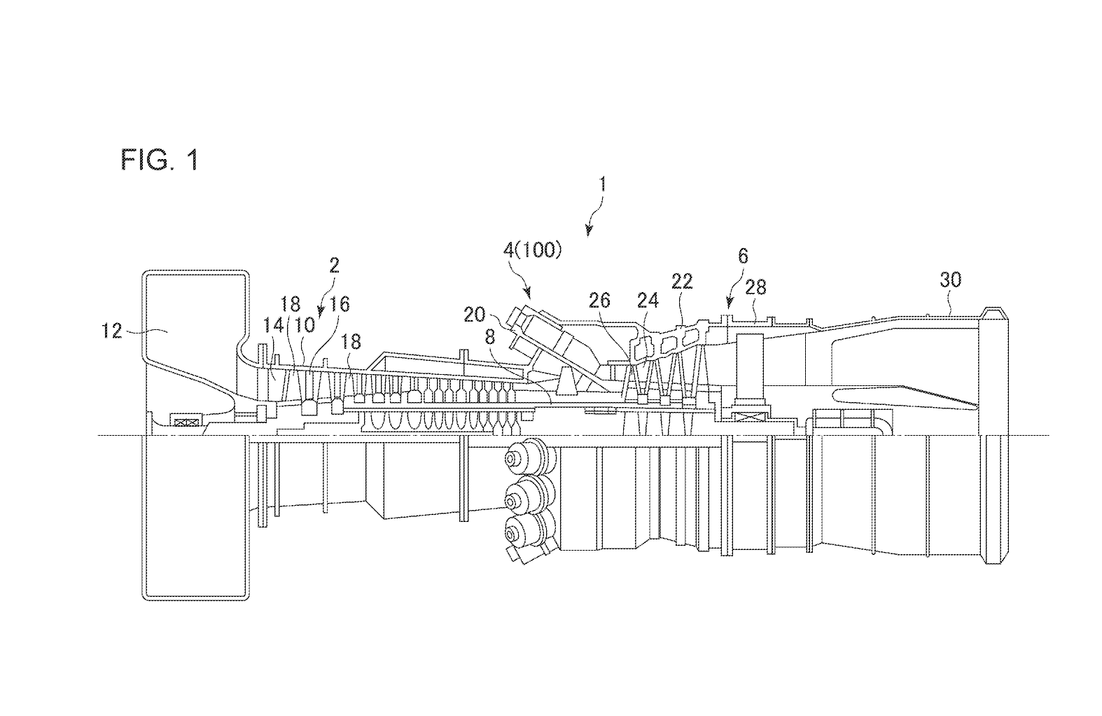

First, with reference to FIG. 1, a gas turbine, which is an example of application of a combustion device according to some embodiments, will be described. FIG. 1 is a schematic configuration diagram of a gas turbine 1 according to an embodiment of the present invention.

As depicted in FIG. 1, the gas turbine 1 according to an embodiment includes a compressor 2 for producing compressed air that serves as an oxidant, a combustor 4 (combustion device 100) for producing combustion gas using the compressed air and fuel, and a turbine 6 configured to be rotary-driven by combustion gas. In the case of the gas turbine 1 for power generation, a generator (not illustrated) is connected to the turbine 6, so that rotational energy of the turbine 6 generates electric power.

The configuration example of each component in the gas turbine 1 will be described specifically.

The compressor 2 includes a compressor casing 10, an air inlet 12 for introducing air, disposed on an inlet side of the compressor casing 10, a rotor 8 disposed so as to penetrate through both of the compressor casing 10 and the turbine casing 22 described below, and a variety of vanes disposed in the compressor casing 10. The variety of vanes includes an inlet guide vane 14 disposed adjacent to the air inlet 12, a plurality of stator vanes 16 fixed to the compressor casing 10, and a plurality of rotor vanes 18 implanted on the rotor 8 so as to be arranged alternately with the stator vanes 16. The compressor 2 may include other constituent elements not illustrated in the drawings, such as an extraction chamber. In the above compressor 2, the air introduced from the air inlet 12 flows through the plurality of stator vanes 16 and the plurality of rotor vanes 18 to be compressed to turn into compressed air having a high temperature and a high pressure. The compressed air having a high temperature and a high pressure is sent to the combustor 4 of a latter stage from the compressor 2.

The combustor 4 is disposed in a casing 20. As illustrated in FIG. 1, a plurality of combustors 4 may be disposed in an annular shape centered at the rotor 8 inside the casing 20. The combustor 4 is supplied with fuel and the compressed air produced in the compressor 2, and combusts the fuel to produce combustion gas that serves as a working fluid of the turbine 6. The combustion gas is sent to the turbine 6 in a latter stage from the combustor 4. The configuration example of the combustor 4 will be described later in detail.

The turbine 6 includes a turbine casing 22 and a variety of vanes disposed inside the turbine casing 22. The variety of vanes includes a plurality of stator vanes 24 fixed to the turbine casing 22 and a plurality of rotor vanes 26 implanted on the rotor 8 so as to be arranged alternately with the stator vanes 24. The turbine 6 may include other constituent elements, such as outlet guide vanes and the like. In the turbine 6, the rotor 8 is rotary driven as the combustion gas passes through the plurality of stator vanes 24 and the plurality of rotor vanes 26. In this way, the generator connected to the rotor 8 is driven.

An exhaust chamber 30 is connected to the downstream side of the turbine casing 22 via an exhaust casing 28. The exhaust gas having driven the turbine 6 is discharged outside via the exhaust casing 28 and the exhaust chamber 30.

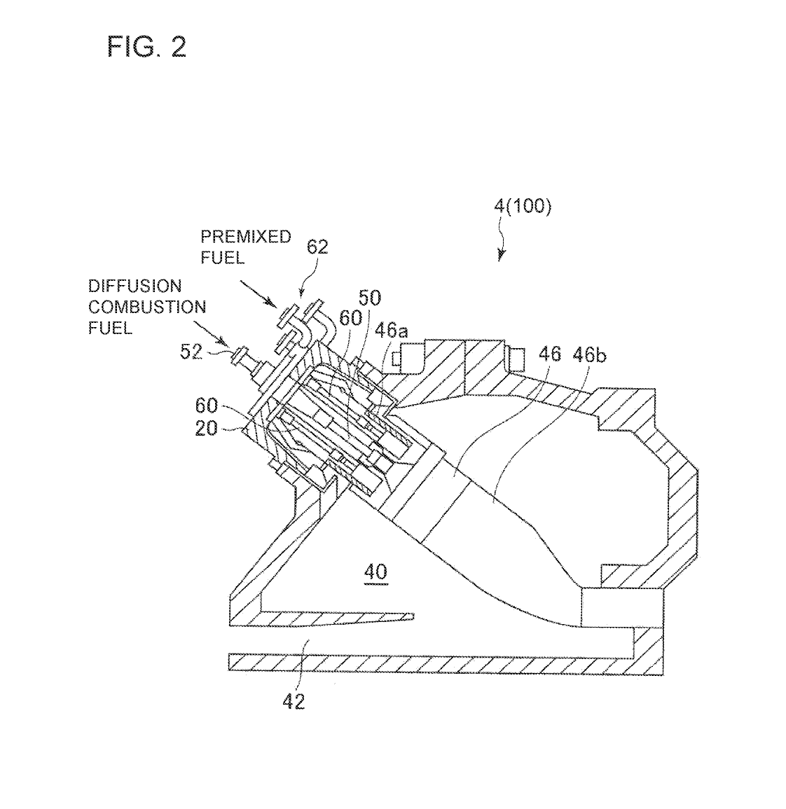

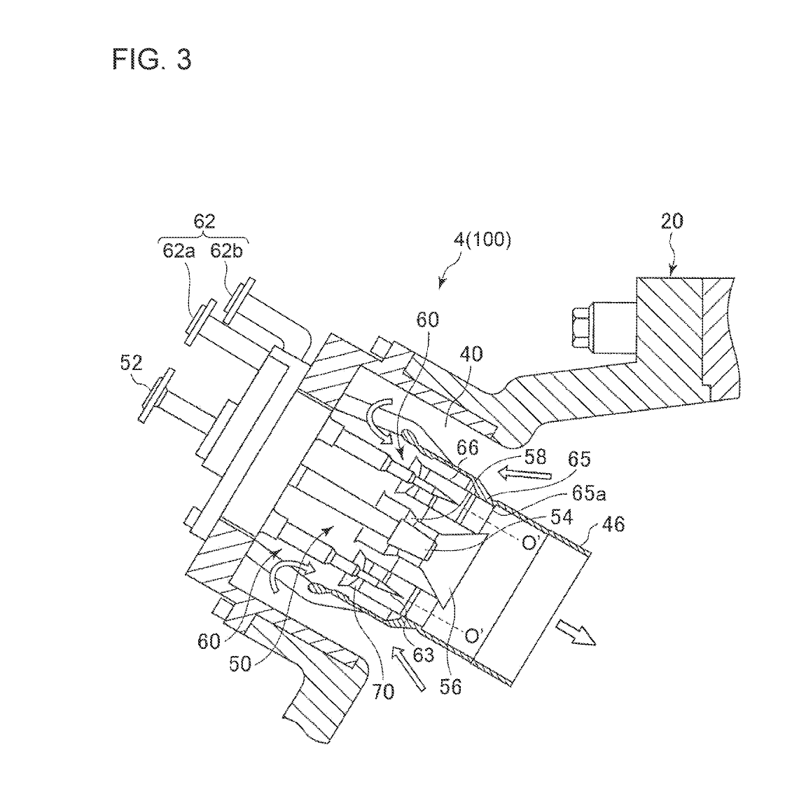

Next, with reference to FIGS. 2 and 3, the specific configuration of the combustor 4 (combustion device 100) according to an embodiment will be described. FIG. 2 is a schematic diagram of a combustor 4 (combustion device 100) according to an embodiment. FIG. 3 is a cross-sectional view of a part of a combustor 4 (combustion device 100) according to an embodiment.

As depicted in FIGS. 2 and 3, a plurality of combustors 4 (combustion devices 100) according to an embodiment is disposed in annular shape centered at the rotor 8 (see FIG. 1). Each combustor 4 includes a combustor liner 46 disposed in a combustor casing 40 defined by the casing 20, a second combustion burner 50 disposed in the combustor liner 46, and a plurality of first combustion burners 60 disposed in the combustor liner 51. The combustor 4 may include other constituent elements such as a bypass line (not illustrated) for allowing the combustion gas to bypass.

For instance, the combustor liner 46 includes a combustor basket 46a disposed around the second combustion burner 50 and the plurality of first combustion burners 60, and a transition piece 46b connected to a tip portion of the combustor basket 46a.

The second combustion burner 50 is disposed along the center axis of the combustor liner 46. Further, the plurality of first combustion burners 60 are arranged at a distance from one another so as to surround the second combustion burner 50.

The second combustion burner 50 includes a second nozzle (nozzle) 54 connected to a fuel port 52, a cone 56 disposed so as to surround the second nozzle 54, and a swirler 58 disposed on the outer periphery of the second nozzle 54.

The first combustion burner 60 includes a first nozzle (nozzle) 63 connected to a fuel port 62, a burner cylinder (nozzle casing) 66 disposed so as to surround the first nozzle 63, an extension tube 65 connecting the burner cylinder 66 and the combustor liner 46 (e.g. combustor basket 46a), and a swirler 70 disposed on the outer periphery of the first nozzle 63. The fuel port 62 includes at least two fuel ports 62a, 62b. The fuel ports 62a and 62b are connected to a first supply flow passage and a second supply flow passage (not shown) for supplying a fuel, respectively. The first supply flow passage is capable of supplying a fuel to the first nozzle 63 via the fuel port 62a, and the second supply flow passage is capable of supplying a fuel to the first nozzle 63 via the fuel port 62b. The specific configuration of the first combustion burner 60 will be described later.

As depicted in FIG. 3, the extension tube 65 extends from an upstream end surface connected to the burner cylinder 66 and a downstream end surface (extension-tube outlet 65a). Further, FIG. 3 illustrates a flow-path center line O′ passing through the center position of the extension-tube outlet 65a.

As described below, the second combustion burner 50 may be a burner for producing a diffusion combustion flame, and the second nozzle 54 may be a nozzle for injecting a fuel for diffusion combustion. Further, the first combustion burner 60 may be a burner for combusting air-fuel mixture, and the first nozzle 63 may be a nozzle for injecting a premixed fuel.

That is, in the combustor 4 having the above configuration, the compressed air having a high temperature and a high pressure produced in the compressor 2 is supplied into the combustor casing 40 from a casing inlet 42, and then flows into the burner cylinder 66 from the combustor casing 40. The compressed air and fuel supplied from the fuel port 62 are premixed in the burner cylinder 66. At this time, the air-fuel mixture mainly forms a swirl flow due to the swirler 70, and flows into the combustor liner 46. Further, the compressed air and fuel injected from the second combustion burner 50 via the fuel port 52 are mixed in the combustor liner 46, and ignited by a pilot light (not illustrated) to be combusted, whereby combustion gas is produced. At this time, a part of the combustion gas diffuses to the surroundings with flames, which ignites the air-fuel mixture flowing into the combustor liner 46 from each of the first combustion burners 60 to cause combustion. Specifically, the diffusion combustion flame due to the diffusion combustion fuel injected from the second combustion burner 50 can hold flames for performing stable combustion of air-fuel mixture (premixed fuel) from the first combustion burners 60. At this time, a combustion region is formed in, for instance, the combustor basket 46a.

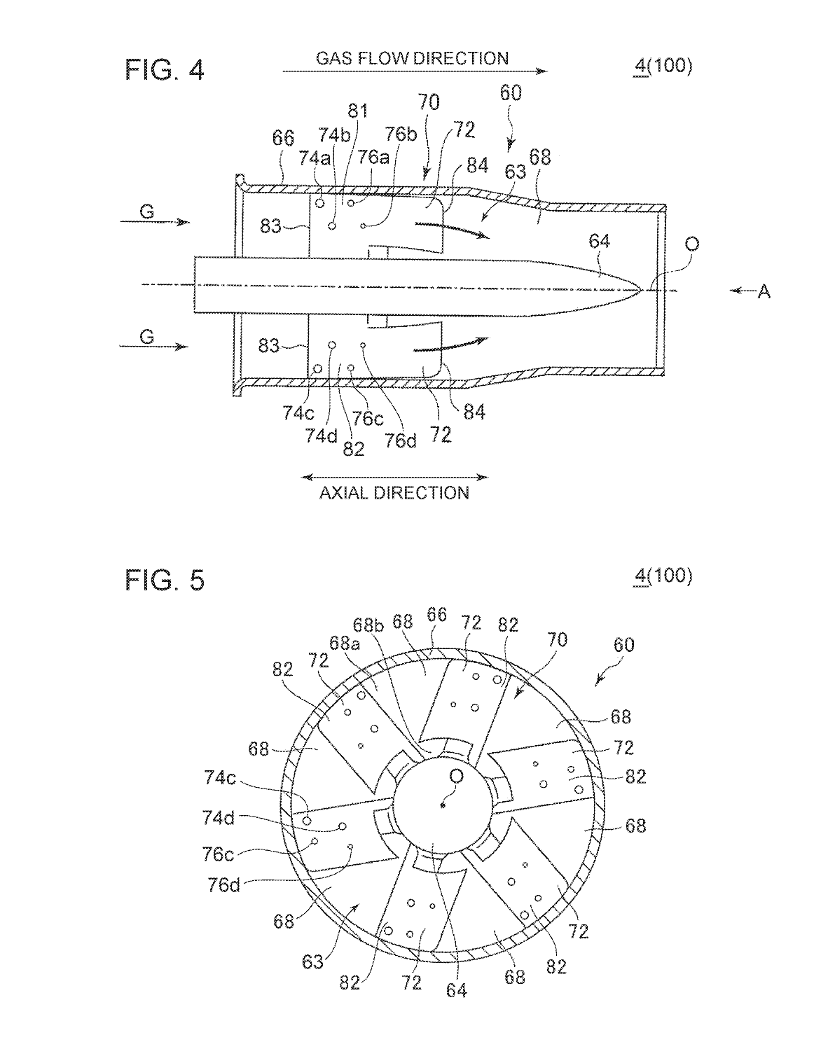

Next, with reference to FIGS. 4 to 10, the specific configuration of a part of the combustor 4 (combustion device 100) according to an embodiment will be described, using the above described first combustion burner 60 as an example.

The combustion burner according to the present invention is not limited to the first combustion burner 60, and the configuration of the present embodiment can be applied to a combustion burner of any type as long as the combustion burner includes a swirler (swirl vane) in an axial flow passage around a nozzle. For instance, in an embodiment, the combustion burner may be a combustion burner which mainly performs diffusive combustion like the second combustion burner 50 disposed in the combustors 4 of the gas turbine 1, or may be a combustion burner disposed in a device other than the gas turbine 1.

That is, the nozzle according to the present invention is not limited to the first nozzle 63. In an embodiment, the nozzle may be a second nozzle 54 disposed surrounded by a plurality of first nozzles 63. Further, the nozzle according to the present invention may be a nozzle for injecting a premixed fuel, or a nozzle for injecting a fuel for diffusion combustion.

FIG. 4 is a partial cross-sectional view of the combustor 4 (combustion device 100) according to an embodiment, including the first combustion burner 60. FIG. 5 is a view taken in the direction of the arrow A of the combustor 4 (combustion device 100) depicted in FIG. 4.

As shown in FIGS. 4 and 5, in the combustor 4 according to an embodiment, the first combustion burner 60 includes a burner cylinder (nozzle casing) 66 and the first nozzle 63. The burner cylinder 66 has an inner peripheral surface which defines an axial flow passage 68 along the axial direction of the first nozzle 63, and the first nozzle 63 is disposed in the axial flow passage 68. The first nozzle 63 includes a nozzle body 64 having a tubular shape and extending along the axial flow passage 68, and a swirler 70 including at least one swirler vane 72.

Herein, the tubular shape does not necessarily refer to a cylindrical shape in the strict sense. In other words, the nozzle body 64 may have a shape which is at least partially cylindrical, and which changes in diameter in the axial direction of the cylindrical shape. For instance, as shown in FIG. 4, the nozzle body 64 may have a cylindrical shape which is tapered at one side in the center axis direction.

The burner cylinder 66 is disposed concentrically with the nozzle body 64 and so as to surround the first nozzle 63 including the nozzle body 64 and the swirler vane 72. Specifically, the axis of the burner cylinder 66 substantially coincides with the axis O of the nozzle body 64, and the diameter of the burner cylinder 66 is larger than the diameter of the first nozzle 63.

Further, gas (fluid) G such as compressed air flows through the axial flow passage 68 defined by the inner peripheral surface of the burner cylinder 66, from the upstream side (left side in FIG. 4) toward the downstream side (right side in FIG. 4).

The first nozzle 63 is connected to the fuel ports 62 (62a, 62b) (see FIGS. 2 and 3) as described above, and fuel is supplied from the fuel ports 62 (62a, 62b). The fuel may be gas or liquid, and the type of the fuel is not particularly limited. Further, the second nozzle 54 and the first nozzle 63 may be supplied with different types of fuel. For instance, the second nozzle 54 may be supplied with an oil fuel while the first nozzle 63 is supplied with a gas fuel such as natural gas fuel.

The swirler 70 is configured to swirl gas flowing through the axial flow passage 68, and includes at least one swirler vane 72. In an example illustrated in FIGS. 4 and 5, the swirler 70 includes six swirl vanes 72 disposed radially from the nozzle 64 at the center. In FIG. 4, as a matter of convenience, the drawings illustrate only two swirl vanes 72 disposed at the positions of 0 and 180 angular degrees along the circumferential direction (in the state of FIG. 4, four swirl vanes 72 in total would be actually visible).

The swirler vanes 72 are disposed in the axial flow passage 68 extending in the axial direction (direction of the axis O) of the nozzle body 64 around the nozzle body 64, so as to protrude outward in the radial direction from the nozzle body 64 in the radial direction of the nozzle body 64, and configured to apply a swirl force to the gas flowing through the axial flow passage 68. Each swirl vane 72 has a pressure surface 81, a suction surface 82, a leading edge 83 being an upstream edge in the flow direction of the gas (the axial direction of the nozzle body 64), and a trailing edge 84 being a downstream edge in the flow direction of the gas (the axial direction of the first nozzle 63).

A plurality of injection holes are formed on the swirler vanes 72 and/or the nozzle body 64. The plurality of injection holes include at least one first injection hole 74 having an opening on the surface of the swirler vane 72, and at least one second injection hole 76 having an opening on the surface of the swirler vane 72 or the nozzle body 64. In the examples shown in FIGS. 4 and 5, as the first injection hole, first injection holes 74a, 74b are formed on the pressure surface 81 of the swirler vane 72, and first injection holes 74c, 74d are formed on the suction surface 82 of the swirler vane 72. Further, as the second injection hole 76, second injection holes 76a, 76b are formed on the pressure surface 81 of the swirler vane 72, and second injection holes 76c, 76d are formed on the suction surface 82 of the swirler vane 72.

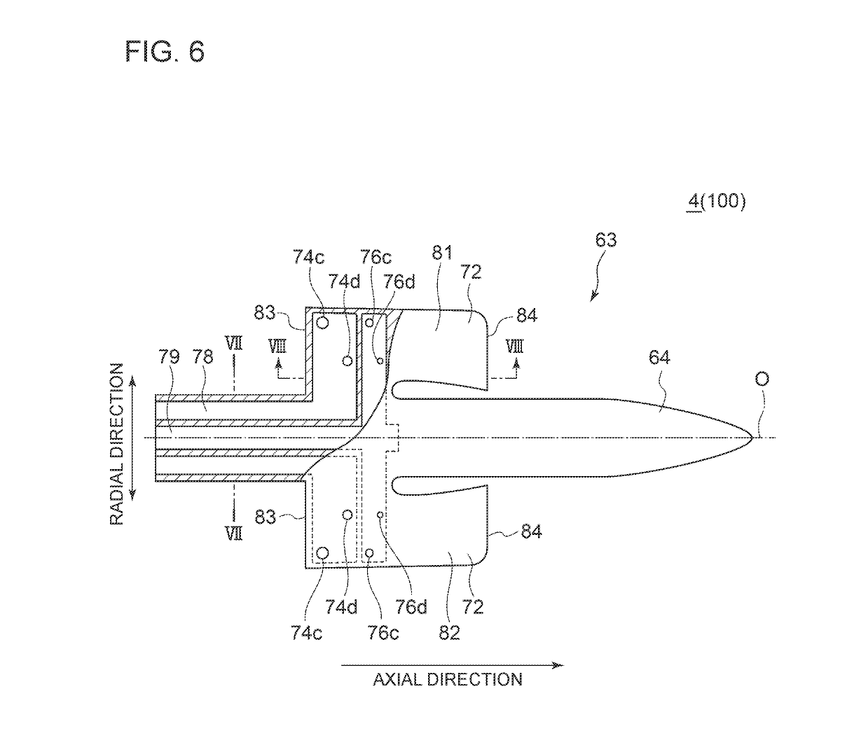

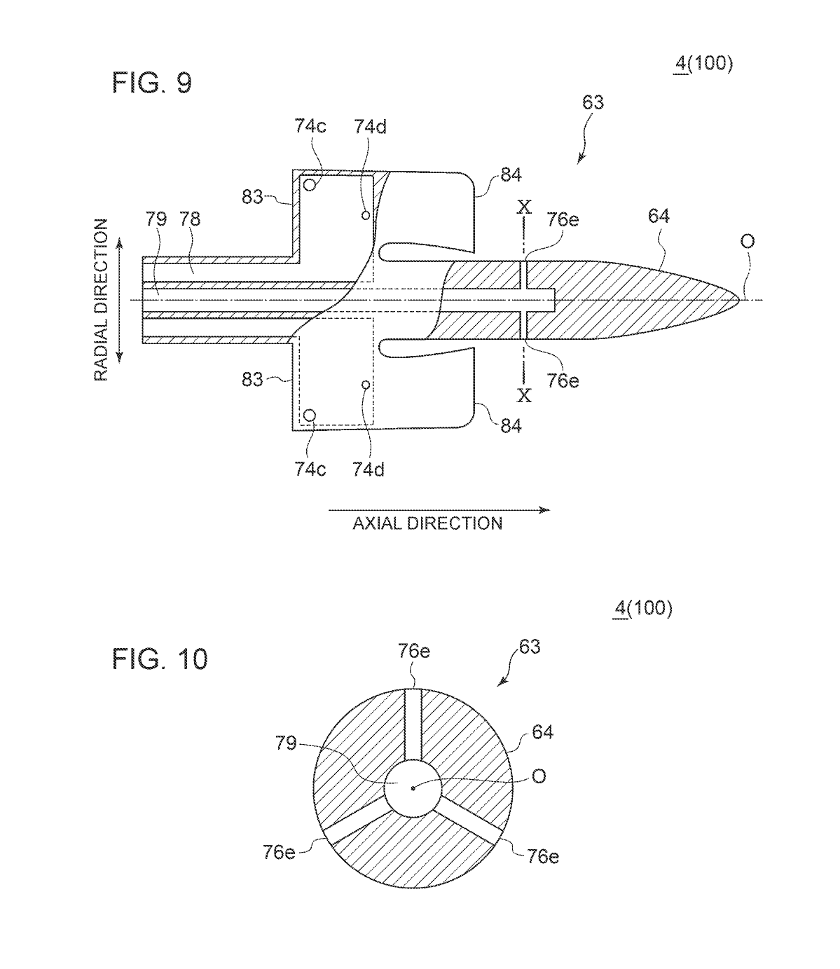

The first injection holes 74 and the second injection holes 76 are in communication with the first fuel flow passage 78 and the second fuel flow passage 79 (see FIGS. 6 and 9; described below) disposed inside the nozzle body 64, respectively. Fuel injected from the first injection holes 74 and the second injection holes 76 is mixed with gas (e.g. compressed air serving as an oxidant) to become air-fuel mixture (fuel gas), and is sent to the combustor liner 46 to be combusted.

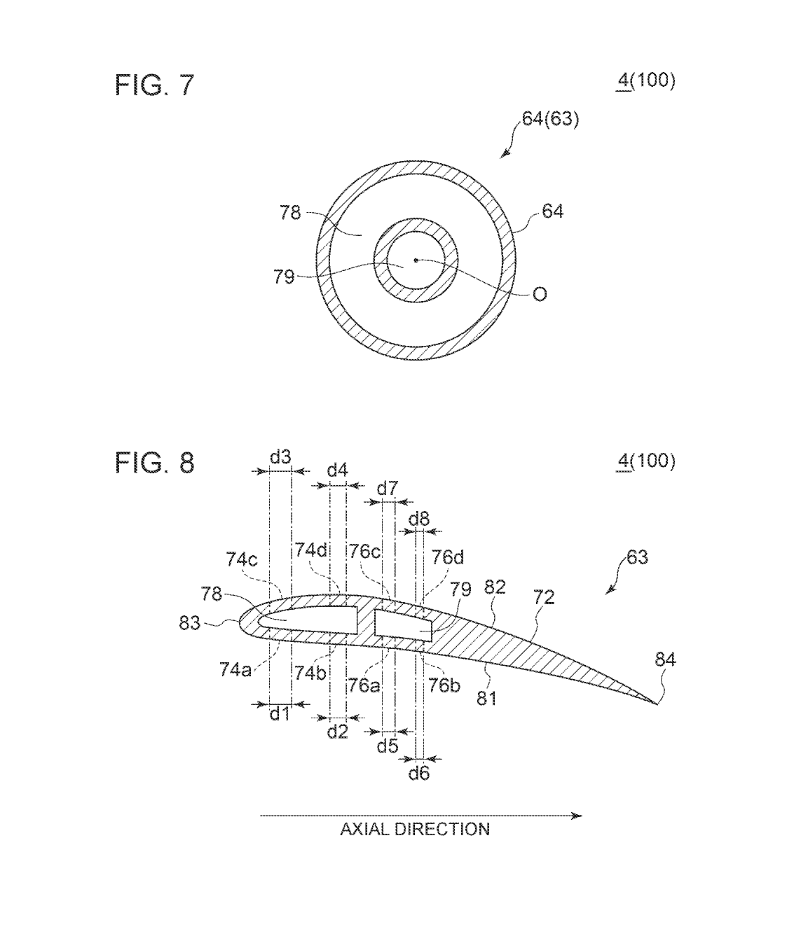

FIGS. 6 and 9 are each a partial cross-sectional view taken along the axial direction of the nozzle according to an embodiment. FIG. 7 is a cross-sectional view taken along line VII-VII in FIG. 6. FIG. 8 is a cross-sectional view taken along line VIII-VIII in FIG. 9. FIG. 10 is a cross-sectional view of the nozzle shown in FIG. 9, taken along line X-X. In the embodiment shown in FIGS. 6 to 8, similarly to the examples shown in FIGS. 4 and 5, as the first injection hole 74, first holes 74a, 74b are formed on the pressure surface 81 of the swirler vane 72, and first injection holes 74c, 74d are formed on the suction surface 82 of the swirler vane 72. Further, as the second injection hole 76, second injection holes 76a, 76b are formed on the pressure surface 81 of the swirler vane 72, and second injection holes 76c, 76d are formed on the suction surface 82 of the swirler vane 72.

Further, in the embodiment shown in FIGS. 9 and 10, as the first injection hole 74, first injection holes 74a, 74b are formed on the pressure surface 81 of the swirler vane 72, and first injection holes 74c, 74d are formed on the suction surface 82 of the swirler vane 72. Further, as the second injection hole 76, three second injection holes 76e are formed on the nozzle body. As shown in FIGS. 9 and 10, the three second injection holes 76e are disposed at substantially regular intervals along the circumferential direction of the nozzle body 64. That is, in a cross section orthogonal to the axial direction (see FIG. 10), the three second injection holes 76e are disposed at intervals of approximately 120 degrees about the axial center O.

Hereinafter, the first injection holes 74a to 74d are collectively referred to as the first injection holes 74, and the second injection holes 76a to 76e are collectively referred to as the first injection holes 74.

As shown in FIGS. 6 and 9, inside the nozzle body 64, the first fuel flow passage 78 and the second fuel flow passage 79 are provided separately, each extending along the axial direction of the nozzle body 64. As shown in FIG. 6 for instance, the first fuel flow passage 78 and the second fuel flow passage 79 may include a part extending through the swirler vane 72 in the radial direction of the nozzle body 64.

Further, the first fuel flow passage 78 is in communication with each of the first injection holes 74, and the second fuel flow passage 79 is in communication with each of the second injection holes 76.

Further, the first fuel flow passage 78 and the second fuel flow passage 79 may be supplied with the same fuel, or may be supplied with different types of fuel from one another. Further, the first fuel flow passage 78 and the second fuel flow passage 79 may be supplied with a fuel in the form of gas, or in the form of liquid. A gas fuel may be supplied to both of the first fuel flow passage 78 and the second fuel flow passage 79, or a liquid fuel may be supplied to both of the first fuel flow passage 78 and the second fuel flow passage 79. Alternatively, a gas fuel may be supplied to one of the first fuel flow passage 78 or the second fuel flow passage 79, and a liquid fuel may be supplied to the other one of the first fuel flow passage 78 or the second fuel flow passage 79.

As described above, with the first fuel flow passage 78 and the second fuel flow passage 79 being in communication with the first injection holes 74 and the second injection holes 76 for injecting fuel, respectively, it is possible to design the first fuel flow passage 78 and the first injection holes 74 suitably according to the characteristics of the fuel that flows through the first fuel flow passage 78, and design the second fuel flow passage 79 and the second injection holes 76 suitably according to the characteristics of the fuel that flows through the second fuel flow passage 79.

In some embodiments, the total area of the first injection holes 74 is greater than the total area of the second injection holes 76. Herein, the total area of the first injection holes 74 refers to the total of the opening areas or the flow-passage areas of all of the first injection holes 74, and the total area of the second injection holes 76 refers to the total of the opening areas or the flow-passage areas of all of the second injection holes 76.

For instance, in the embodiment shown in FIG. 6, the sum of the opening areas of four first injection holes 74a to 74d disposed on the swirler vane 72 is greater than the sum of the opening areas of four second injection holes 76a to 76d disposed on the swirler vane 72. Further, in the embodiment shown in FIG. 9, the sum of the opening areas of four first injection holes 74a to 74d disposed on the swirler vane 72 is greater than the sum of the opening areas of three second injection holes 76e disposed on the nozzle body 64.

Accordingly, with the total area of the first injection holes 74 being greater than the total area of the second injection holes 76, a greater amount of fuel is injected from the first injection holes 74 than from the second injection holes 76. Thus, in a case where fuel is injected from the first injection holes 74, the differential pressure across the first injection holes can be easily maintained. Furthermore, with the total area of the second injection holes 76 being smaller than the total area of the first injection holes 74, the differential pressure across the second injection holes 76 can be easily maintained, even though the flow rate of fuel injected from the second injection holes 76 is relatively low. Thus, the differential pressure before and after fuel injection can be easily maintained in the combustion device 100.

In some embodiments, the flow passage area of the first fuel flow passage 78 is greater than the flow passage area of the second fuel flow passage 79.

For instance, in the embodiment shown in FIG. 6, at the nozzle body 64 on the upstream side of the swirler vane 72 in the flow direction of the fluid in the axial flow passage 68 (see FIG. 4), the flow-passage area of the first fuel flow passage 78 in a cross section orthogonal to the axis of the nozzle body 64 (see FIG. 7) is greater than the flow passage area of the second fuel flow passage 79. Similarly, in the embodiment shown in FIG. 9, at the nozzle body 64, the flow passage area of the first fuel flow passage 78 is greater than the flow passage area of the second fuel flow passage 79.

Further, in the embodiment shown in FIG. 6, the flow passage area of the first fuel flow passage 78 in a cross section orthogonal to the axial direction of the nozzle body 64 (see FIG. 8) is greater than the flow passage area of the second fuel flow passage 79.

Accordingly, with the flow passage area of the first fuel flow passage 78 being greater than the flow passage area of the second fuel flow passage 79, a greater amount of fuel is injected from the first injection holes 74 than from the second injection holes 76. Thus, in a case where fuel is injected from the first injection holes 74, the differential pressure across the first injection holes can be easily maintained. Furthermore, with the flow passage area of the second fuel flow passage 79 being smaller than the flow passage area of the first fuel flow passage 78, the differential pressure across the second injection holes 76 can be easily maintained, even though the flow rate of fuel injected from the second injection holes 76 is relatively low. Thus, the differential pressure before and after fuel injection can be easily maintained in the combustion device 100.

In some embodiments, a ratio of a flow-passage area ratio, which is a ratio of the flow passage area of the first fuel flow passage 78 to the flow passage area of the second fuel flow passage 79, to an injection-hole total area ratio, which is a ratio of a total area of the first injection holes 74 to a total area of the second injection holes 76 (flow passage area ratio/injection-hole total area ratio) is not lower than 0.8 and not higher than 1.2.

For instance, in the embodiment shown in FIG. 6, when the injection-hole total area ratio (total area of first injection holes 74/total area of second injection holes 76), which is a ratio of the total area of the first injection holes 74 (74a to 74d) to the total area of the second injection holes 76 (76a to 76d) is two, the hole diameter of the first injection holes 74 and the second injection holes 76 and the flow-passage diameter of the first fuel flow passage 78 and the second fuel flow passage 79, for instance, are set so that the flow-passage area ratio (flow passage area of the first fuel flow passage 78/flow passage area of the second fuel flow passage 79) which is a ratio of the flow passage area of the first fuel flow passage 78 to the flow passage area of the second fuel flow passage 79 falls within a range of from 1.6 to 2.4.

Accordingly, the ratio of the flow passage area ratio to the injection hole total area ratio is close to one, and thereby it is possible to reduce pressure loss in the first fuel flow passage 78 and the second fuel flow passage 79, which makes it easier to maintain the differential pressure before and after fuel injection in the combustion device 100.

In some embodiments, as shown in FIGS. 4 to 6, 8, and 9, the first injection holes 74 are disposed on the upstream side of the second injection holes 76 in the flow direction of the fluid in the axial flow passage 68.

Accordingly, in a case where the first injection holes 74 are disposed upstream of the second injection holes 76, for the fuel injected from the first injection holes 74, it is possible to increase the mixing distance with air flowing from the upstream side through the axial flow passage 68, as much as the distance between the first injection holes 74 and the second injection holes 76, compared to fuel injected from the second injection holes 76. Thus, it is possible to promote mixing (pre-mixing) of air and fuel injected from the first injection hole 74, and obtain a good combustion efficiency in the combustion device 100.

In an embodiment where a plurality of first injection holes 74 or a plurality of second injection holes 76 are formed on the nozzle body 64 or the swirler vane 72, the plurality of first injection holes 74 and/or the plurality of second injection holes 76 may be disposed on different positions from one another in the axial direction or the radial direction of the nozzle body 64. Hereinafter, the axial direction of the nozzle body 64 and the radial direction of the nozzle body 64 may be referred to as merely the axial direction and the radial direction, respectively.

In some embodiments, at least one of the plurality of first injection holes 74 and at least one of the plurality of second injection holes 76 may be disposed on the substantially same position in the radial direction.

For instance, in the example shown in FIG. 4 or 6, the first injection holes 74a, 74c positioned on the relatively outer side in the radial direction, of the plurality of first injection holes 74, and the second injection holes 76a, 76c positioned on the relatively outer side in the radial direction, of the plurality of second injection holes 76, are disposed in the same position in the radial direction (that is, the distance from the center axis from the nozzle body 64 is substantially the same). Furthermore, in the same example, the first injection holes 74b, 74d positioned on the relatively inner side in the radial direction, of the plurality of first injection holes 74, and the second injection holes 76b, 76d positioned on the relatively inner side in the radial direction, of the plurality of second injection holes 76, are disposed in the same position in the radial direction (that is, the distance from the center axis from the nozzle body 64 is substantially the same).

In the embodiment shown in FIGS. 6 and 9, as described above, the swirler vane 72 has four first injection holes 74, including: the first injection holes 74a, 74b formed on the pressure surface 81, and the first injection holes 74c, 74d formed on the suction surface 82. Further, of the two first injection holes 74a, 74b formed on the pressure surface 81, the first injection hole 74a is disposed on the outer side in the radial direction, and the first injection hole 74b is disposed on the inner side in the radial direction. Further, of the two first injection holes 74a, 74d formed on the suction surface 82, the first injection hole 74c is disposed on the outer side in the radial direction, and the first injection hole 74d is disposed on the inner side in the radial direction. The first injection hole 74a and the first injection hole 74c may be disposed in the same position in the radial direction. Further, the first injection hole 74b and the first injection hole 74d may be disposed in the same position in the radial direction.

Further, in the embodiment shown in FIG. 6, the plurality of second injection holes 76a, 76b, 76c, 76d formed on the swirler vane 72 are disposed in different positions in the radial direction, like the first injection holes 74a, 74b, 74c, and 74d.

Accordingly, with the plurality of first injection holes 74 or the plurality of second injection holes 76 being disposed on different positions from one another in the radial direction of the nozzle body 64, it is possible to smoothen the flow of fuel in the first fuel flow passage 78. Thus, it is possible to supply fuel smoothly from the first injection holes 74.

Further, in an embodiment where a plurality of first injection holes 74 or a plurality of second injection holes 76 are formed on the nozzle body 64 or the swirler vane 72, of the plurality of first injection holes 74 and/or the plurality of second injection holes 76, outer injection holes disposed on the outer side in the radial direction may be disposed upstream in the flow direction of the gas G (i.e. left-hand side in FIGS. 4, 6, and 9) in the axial flow passage 68 (see FIG. 4), compared to the inner injection holes disposed on the inner side in the radial direction.

In the embodiment shown in FIGS. 6 and 9, of the first injection holes 74a, 74b formed on the pressure surface 81 of the swirler vane 72, the first injection hole 74a, which is an outer injection hole, is disposed on the upstream side of the first injection hole 74b, which is an inner injection hole, with respect to the flow direction of the gas G in the axial flow passage 68 (see FIG. 4). Furthermore, of the first injection holes 74c, 74d formed on the suction surface 82 of the swirler vane 72, the first injection hole 74c, which is an outer injection hole, is disposed on the upstream side of the first injection hole 74d, which is an inner injection hole, with respect to the flow direction of the gas G in the axial flow passage 68 (see FIG. 4).

Further, in the embodiment shown in FIG. 6, the plurality of second injection holes 76a, 76b, 76c, 76d formed on the swirler vane 72 are disposed in different positions in the axial direction, like the first injection holes 74a, 74b, 74c, and 74d.

Accordingly, of the plurality of first injection holes 74 or the plurality of second injection holes 76, with the outer injection holes disposed on the upstream side of the inner injection holes in the flow direction of the gas G in the axial flow passage 68, mixing of air and fuel injected from the outer injection holes disposed on the radially outer side where the flow passage area of air is relatively large is promoted further in the axial flow passage 68, and thus it is possible to achieve an even higher combustion efficiency.

Further, in an embodiment where a plurality of first injection holes 74 or a plurality of second injection holes 76 are formed on the nozzle body 64 or the swirler vane 72, of the plurality of first injection holes 74 and/or the plurality of second injection holes 76, outer injection holes disposed on the outer side in the radial direction may have a greater diameter than inner injection holes disposed on the inner side in the radial direction.

In the embodiment shown in FIGS. 6 and 9, of the first injection holes 74a, 74b formed on the pressure surface 81 of the swirler vane 72, the hole diameter dl of the first injection hole 74a, which is an outer injection hole, is greater than the hole diameter of the first injection hole 74b, which is an inner injection hole. Furthermore, of the first injection holes 74c, 74d formed on the suction surface 82 of the swirler vane 72, the hole diameter d3 of the first injection hole 74c, which is an outer injection hole, is greater than the hole diameter d4 of the first injection hole 74d, which is an inner injection hole.

In the embodiment shown in FIG. 6, also of the second injection holes 76a, 76b, 76c, and 76d formed on the swirler vane 72, the hole diameter d5 of the second injection hole 76a and the hole diameter d7 of the second injection hole 76c, which are outer injection holes, are greater than the hole diameter d6 of the second injection hole 76b and the hole diameter d8 of the second injection hole 76d, which are inner injection holes.

Accordingly, of the plurality of first injection holes 74 or the plurality of second injection holes 76, with the hole diameter of the outer injection holes being greater than the hole diameter of the inner injection holes, the flow rate of the fuel injected from the outer injection hole increases even further, and thus it is possible to inject a greater amount of fuel from the outer injection holes to promote mixing with air, which makes it possible to obtain a higher combustion efficiency.

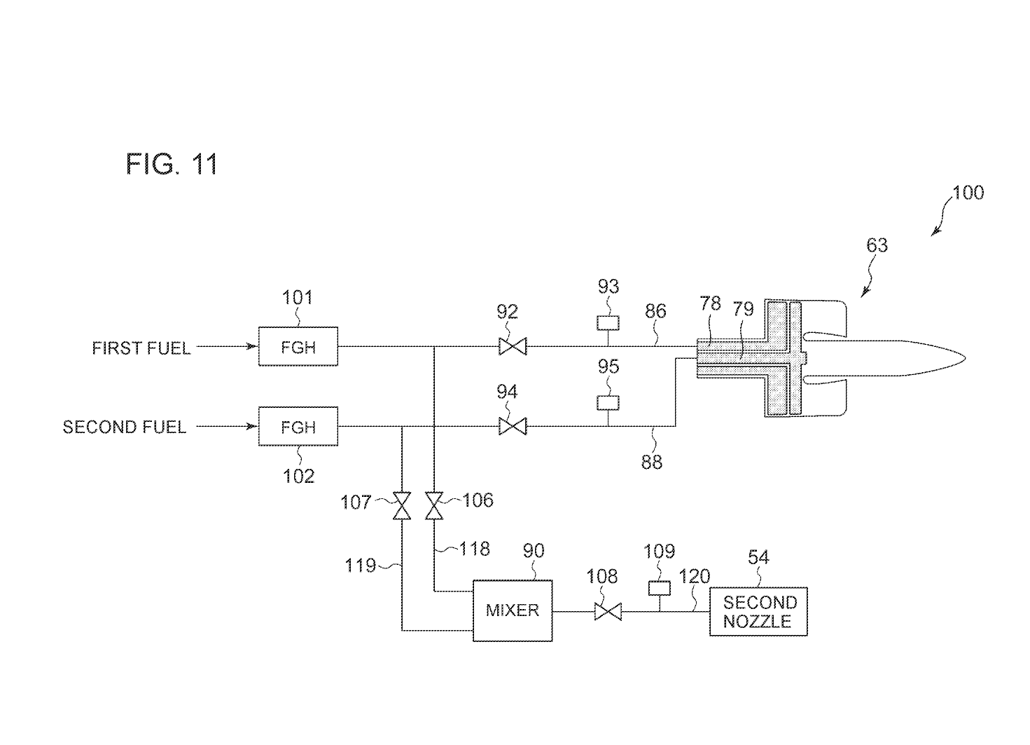

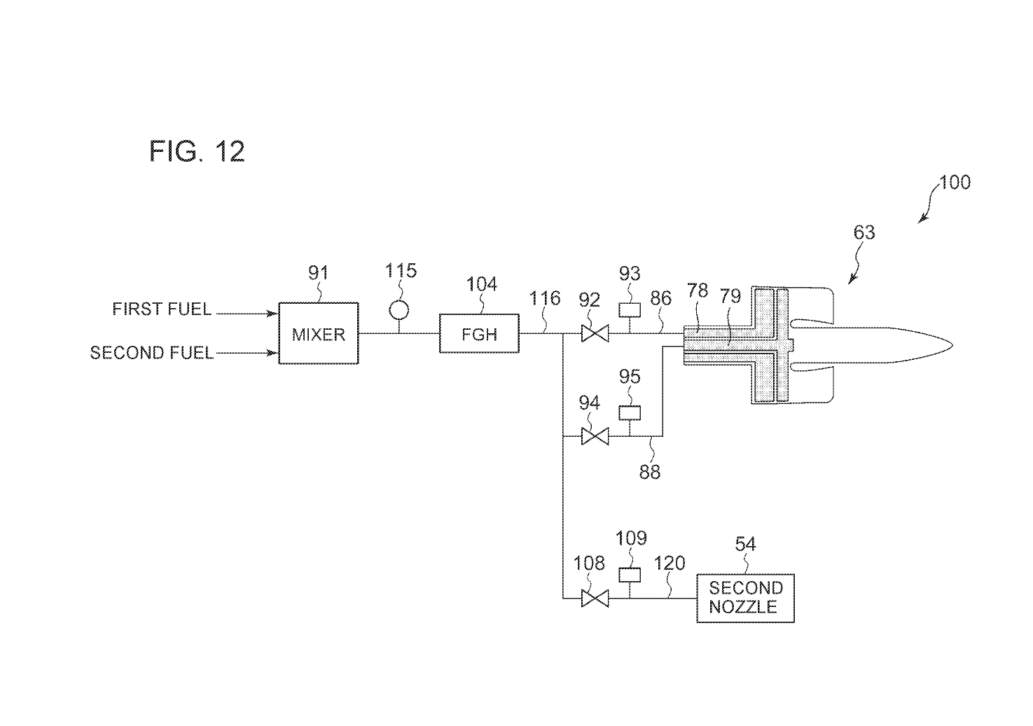

Next, with reference to FIGS. 11 and 12, the configuration of the fuel supply system of the combustor 4 (combustion device 100) according to an embodiment will be described. FIGS. 11 and 12 are each a configuration diagram of a fuel supply system of the combustor 4 (combustion device 10) according to an embodiment, showing a supply system of a fuel to be supplied to the first nozzle 63.

In some embodiments, as shown in FIGS. 11 and 12, the combustion device 100 including the combustor 4 includes the first supply flow passage 86 connected to the first fuel flow passage 78 of the first nozzle 63, and the second supply flow passage 88 connected to the second fuel flow passage 79 of the first nozzle 63. Through the first supply flow passage 86 and the second supply flow passage 88, the first fuel and/or the second fuel from the first fuel tank 96 and/or the second fuel tank 98 can flow.

A flow-rate adjustment valve 92 capable of adjusting the flow rate of a fuel flowing through the first supply flow passage 86 is disposed in the first supply flow passage 85, whereby it is possible to supply a certain amount of fuel to the first fuel flow passage 78 via the flow-rate adjustment valve 92. Furthermore, a flow-rate adjustment valve 94 capable of adjusting the flow rate of a fuel flowing through the second supply flow passage 88 is disposed in the second supply flow passage 88, whereby it is possible to supply a certain amount of fuel to the second fuel flow passage 79 via the flow-rate adjustment valve 94.

Furthermore, flow rate meters 93, 95 are disposed in the first supply flow passage 86 and the second supply flow passage 88.

In the embodiment shown in FIG. 11, a fuel heater 101 is disposed in the first supply flow passage 86. The first fuel is heated to a predetermined temperature by the fuel heater (FGH) 101, flows through the first supply flow passage 86, and then is supplied to the first fuel flow passage 78 of the first nozzle 63 via the fuel port 62a (see FIGS. 2 and 3), for instance. Further, a fuel heater (FGH) 102 is disposed in the second supply flow passage 88. The second fuel is heated to a predetermined temperature by the fuel heater 102, flows through the second supply flow passage 88, and then is supplied to the second fuel flow passage 79 of the first nozzle 63 via the fuel port 62a (see FIGS. 2 and 3), for instance.

Further, the fuel supplied to the first fuel flow passage 78 and the second fuel flow passage 79 of the first nozzle 63 via the fuel ports 62a, 62b from the first supply flow passage 86 and the second supply flow passage 88 corresponds to “premixed fuel” in FIG. 2.

In some embodiments, the first fuel supplied to the first fuel flow passage 78 has a smaller calorific value than the second fuel supplied to the second fuel flow passage 79.

In this case, the first fuel flow passage 78 and the first fuel injection hole 74 of the first nozzle 63 can be designed suitably according to the characteristics of the first fuel having a relatively small calorific value (low-calorie fuel), and the second fuel flow passage 79 and the second injection hole 76 can be designed suitably according to the characteristics of the fuel having a relatively large calorific value (high-calorie fuel).

For instance, the total area of the first injection holes 74 may be greater than the total area of the second injection holes 76. In this case, the flow rate of the first fuel (low-calorie fuel) injected from the first injection hole 74 is relatively high, and the total area of the second injection hole 76 is relatively small. Thus, the differential pressure is likely to be maintained across the second injection holes 76 for injecting the second fuel having a relatively low flow rate (high-calorie fuel). Thus, the differential pressure before and after fuel injection can be easily maintained in the combustion device 100.

Further, the total area ratio, which is a ratio of the total area of the first injection holes 74 to the total area of the second injection holes 76, may be determined in accordance with the calorific value ratio, which is a ratio of the calorific value of the first fuel to the calorific value of the second fuel. For instance, the total area of the first injection holes 74 and the total area of the second injection holes 76 may be determined so that the total area ratio is an inverse ratio of the calorific value ratio.

Accordingly, it is possible to reduce variation of combustion heat between the time using the first fuel (low-calorie fuel) and the time using the second fuel (high-calorie fuel), and thus it is possible to combust the fuel stably even in a case where the first fuel (low-calorie fuel) and the second fuel (high-calorie fuel) are used in turn.

Further, for instance, the first injection holes 74 may be disposed upstream of the second injection holes 76. In this case, for the first fuel (low-calorie fuel) injected from the first injection holes 74 at a high flow rate, it is possible to increase the mixing distance with air flowing from the upstream side through the axial flow passage 68, as much as the distance between the first injection holes 74 and the second injection holes 76, compared to the second fuel (high-calorie fuel) injected from the second injection holes 76 at a relatively low flow rate. Thus, it is possible to promote mixing (pre-mixing) of air and the first fuel (low-calorie fuel) having a relatively high flow rate injected from the first injection hole 74, and obtain a high combustion efficiency in the combustion device 100 as a whole.

In the embodiment shown in FIG. 12, each of the first supply flow passage 86 and the second supply flow passage 88 is connected to a mixer 91 via a mixed fuel line 116. The first fuel and the second fuel flow into the mixer 91, and are mixed in the mixer 91, whereby a mixed fuel is produced.

A fuel heater 104 is disposed in the mixed fuel line 116. The mixed fuel produced in the mixer 91 is heated to a predetermined temperature by the fuel heater 104 in the mixed fuel line 116, flows through the first supply flow passage 86, and is supplied to the first fuel flow passage 78 of the first nozzle 63 via the fuel port 62a (see FIGS. 2 and 3), for instance, and also flows through the second supply flow passage 88, and is supplied to the second fuel flow passage 79 of the first nozzle 63 via the fuel port 62b (see FIGS. 2 and 3), for instance.

Further, in the mixed fuel line 116 between the mixer 91 and the fuel heater 104, a calorimeter 115 for measuring the calorific value of the mixed fuel flowing from the mixer 91 to the fuel heater 104 is disposed.

Herein, the flow-rate adjustment valve 92 and the flow-rate adjustment valve (second valve) 94 disposed in the first supply flow passage 86 and the second supply flow passage 88 are valves capable of adjusting the flow rate of mixed fuel supplied to the first fuel flow passage 78 and the second fuel flow passage 79, respectively.

In this embodiment, a mixed fuel obtained by mixing the first fuel and the second fuel can be supplied to the first fuel flow passage 78 and the second fuel flow passage 79.

The flow rate of the mixed fuel supplied to the second fuel flow passage 79 can be adjusted by the flow-rate adjustment valve (second valve) 94. Thus, by adjusting the flow rate of the mixed fuel in the second fuel flow passage 79 with the flow-rate adjustment valve (second valve) 94, it is possible to adjust the flow rate of the entire mixed fuel.

Herein, the first fuel and the second fuel may have different calorific values from one another. In this case, the opening degree of the flow-rate adjustment valve (second valve) 94 may be adjusted in accordance with the mixing ratio of the first fuel and the second fuel in the mixed fuel.

In this case, it is possible to adjust the flow rate of the entire mixed fuel suitably in accordance with the mixing ratio of the first fuel and the second fuel.

Further, the mixing ratio of the mixed fuel may be adjusted by adjusting the flow rate of the first fuel and the second fuel flowing into the mixer 91 with a flow-rate adjustment valve or the like. Alternatively, the mixing ratio of the mixed fuel may be determined from a measurement result of the calorimeter 115.

For instance, if the mixed fuel contains a large amount of first fuel and has a relatively small calorific value, the opening degree of the flow-rate adjustment valve (second valve) 94 may be increased to obtain a high flow rate, thereby supplying the mixed fuel to both of the first fuel flow passage 78 and the second fuel flow passage 79. Further, if the mixed fuel contains a large amount of second fuel and has a relatively large calorific value, the opening degree of the flow-rate adjustment valve (second valve) 94 may be reduced to obtain a relatively low flow rate, thereby reducing the flow rate of the second fuel flow passage 79 and supplying the mixed fuel to mainly the first fuel flow passage 78.

In this case, when the first injection holes 74 are disposed on the upstream side of the second injection holes 76 with respect to the flow direction of the fluid in the axial flow passage 68, the opening degree of the flow-rate adjustment valve 92 may be maintained regardless of the mixing ratio of the mixed fuel, so that the mixed fuel is always supplied to the first fuel flow passage 78. In this case, for the mixed fuel injected constantly regardless of the mixing ratio of the mixed fuel (i.e. mixed fuel injected from the first injection hole 74), it is possible to ensure a relatively long mixing distance with air that flows from the upstream side through the axial flow passage 68, and thus it is possible to promote mixing (pre-mixing) of fuel and air even further.

Further, in the embodiment shown in FIG. 12, the mixed fuel obtained by mixing the first fuel and the second fuel is supplied to the first fuel flow passage 78 and the second fuel flow passage 79, and thus it is sufficient if the heater for heating the fuel is provided so as to heat the fuel after mixing. That is, as a heater for heating the mixed fuel, it is sufficient if the fuel heater 104 disposed in the mixed fuel line 116 is provided. Thus, it is possible to reduce the costs compared to a case where a heater is disposed separately for each of the first fuel and the second fuel.

In some embodiments, besides the first nozzle 63, the first fuel and the second fuel may be also supplied to a nozzle other than the first nozzle 63.

For instance, in an embodiment, besides the first nozzle 63, the first fuel and the second fuel are also supplied to the second nozzle 54 (see FIG. 2 or FIG. 3).

Alternatively, in an embodiment, besides the first nozzle 63, the first fuel and the second fuel may be also supplied to a third nozzle (e.g. top hat nozzle; not depicted) other than the first nozzle and the second nozzle.

In the embodiment shown in FIGS. 11 and 12, for the second nozzle 54 (see FIGS. 2 and 3), the first fuel and the second fuel are supplied as diffusion combustion fuels.

In the example shown in FIG. 11, the mixer 90 is disposed in branch lines 118, 119 branched from the first supply flow passage 86 and the second supply flow passage 88, and the mixer 90 and the second nozzle 54 are connected via a diffusion combustion fuel supply flow passage 120. Further, valves 106, 107 for adjusting the flow rate of the first fuel and the second fuel to be supplied to the mixer 90 are disposed in the branch lines 118, 119. Further, a valve 108 and a flow rate meter 109 for adjusting the flow rate of the diffusion combustion fuel supplied to the second nozzle 54 from the mixer 90 is disposed in the diffusion combustion fuel supply flow passage 120.

The first fuel and the second fuel from the first fuel tank 96 and the second fuel tank 98 are heated by the fuel heaters 101, 102, flow into the mixer 90 through the branch lines 118, 119 to be mixed in the mixer 90, whereby a mixed fuel is produced. The mixed fuel obtained as described above is supplied to the second nozzle 54 via the fuel port 52, for instance, from the diffusion combustion fuel supply flow passage 120.

In the example shown in FIG. 12, the mixed fuel line 116 and the second nozzle 54 are connected via the diffusion combustion fuel supply flow passage 120. The mixed fuel (mixture of the first fuel and the second fuel) flowing through the mixed fuel line 116 is supplied to the second nozzle 54 via the diffusion combustion fuel supply flow passage 120. Further, a valve 108 and a flow rate meter 109 for adjusting the flow rate of the diffusion combustion fuel supplied to the second nozzle 54 from the mixed fuel line 116 is disposed in the diffusion combustion fuel supply flow passage 120.

In some embodiments, only either one of the first fuel or the second fuel, or a fuel other than the first fuel and the second fuel may be supplied to the second nozzle 54 or the third nozzle (nozzle other than the first nozzle 63 and the second nozzle 54, such as the top hat nozzle).

Embodiments of the present invention were described in detail above, but the present invention is not limited thereto, and various amendments and modifications may be implemented.

Further, in the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

### REFERENCE SIGNS LIST

1 Gas turbine
2 Compressor
4 Combustor
6 Turbine
8 Rotor
10 Compressor casing
12 Air inlet
14 Inlet guide vane
16 Stator vane
18 Rotor vane
20 Casing
22 Turbine casing
24 Stator vane
26 Rotor vane
28 Exhaust casing
30 Exhaust chamber
40 Combustor casing
42 Casing inlet
46 Combustor liner
46a Combustor basket
46b Transition piece
50 Second combustion burner
52 Fuel port
54 Second nozzle
56 Cone
58 Swirler
60 First combustion burner
62 Fuel port
63 First nozzle
64 Nozzle body
65 Extension tube
65a Extension-tube outlet
66 Burner cylinder
68 Axial flow passage
70 Swirler
72 Swirler vane
74, 74a to 74d First fuel injection hole
76, 76a to 76d Second injection hole
78 First fuel flow passage
79 Second fuel flow passage
81 Pressure surface
82 Suction surface
83 Leading edge
84 Trailing edge
86 First supply flow passage
88 Second supply flow passage
90 Mixer
91 Mixer
92 Flow-rate adjustment valve
93 Flow rate meter
94 Flow-rate adjustment valve
95 Flow rate meter
100 Combustion device
101 Fuel heater
102 Fuel heater
104 Fuel heater
106 Valve
107 Valve
108 Valve
109 Flow rate meter
115 calorimeter
116 Mixed fuel line
118 Branch line
119 Branch line
120 Diffusion combustion fuel supply flow passage

1. A combustion device, comprising:
a nozzle casing defining an axial flow passage; and
a nozzle disposed in the axial flow passage,
wherein the nozzle includes:
a nozzle body having a tubular shape extending along the axial flow passage;
a swirler vane protruding radially outward from the nozzle body in a radial direction of the nozzle body, the swirler vane being configured to swirl a fluid flowing through the axial flow passage;
at least one first injection hole having an opening on a surface of the nozzle body or the swirler vane;
at least one second injection hole having an opening on the surface of the nozzle body or the swirler vane;
a first fuel flow passage extending through the nozzle body and being in communication with the at least one first injection hole; and
a second fuel flow passage extending through the nozzle body separately from the first fuel flow passage, and being in communication with the at least one second injection hole,
wherein the combustion device further comprises:
a first supply flow passage capable of supplying a first fuel to the first fuel flow passage; and
a second supply flow passage capable of supplying a second fuel other than the first fuel to the second fuel flow passage,
wherein the first fuel has a smaller calorific value than the second fuel, and
wherein a ratio of a total area of the first injection hole to a total area of the second injection hole is determined on the basis of a ratio of the calorific value of the first fuel to the calorific value of the second fuel.

2. The combustion device according to claim 1,
wherein the first injection hole has a greater a total area than the second injection hole.

3. The combustion device according to claim 2,
wherein the first fuel flow passage has a greater flow passage area than the second fuel flow passage.

4. The combustion device according to claim 3,
wherein a ratio of a flow passage area ratio to an injection hole total area ratio (the flow passage area ratio/the injection hole total area ratio) is not lower than 0.8 and not higher than 1.2,
where the flow passage area ratio is a ratio of the flow passage area of the first fuel flow passage to the flow passage area of the second fuel flow passage, and the injection hole total area ratio is a ratio of the total area of the first injection hole to the total area of the second injection hole.

5. The combustion device according to claim 1,
wherein the first injection hole is disposed upstream of the second injection hole in a flow direction of the fluid in the axial flow passage.

6. The combustion device according to claim 1,
wherein, in the nozzle body or the swirler vane, the at least one first injection hole comprises at least two first injection holes or the at least one second injection hole comprises at least two second injection holes, and
wherein the at least two first injection holes or the at least two second injection holes are disposed on different positions from one another in a radial direction of the nozzle body.

7. The combustion device according to claim 6,
wherein, of the at least two first injection holes or the at least two second injection holes, an outer injection hole disposed on an outer side in the radial direction is disposed upstream of an inner injection hole disposed on an inner side in the radial direction, with respect to a flow direction of the fluid in the axial flow passage.

8. The combustion device according to claim 6,
wherein, of the at least two first injection holes or the at least two second injection holes, an outer injection hole disposed on an outer side in the radial direction has a greater hole diameter than an inner injection hole disposed on an inner side in the radial direction.

9-10. (canceled)

11. The combustion device according to claim 1, further comprising:
a mixer capable of producing a mixed fuel by mixing a first fuel and a second fuel having different calorific values from each other;
a first supply flow passage capable of supplying the mixed fuel to the first fuel flow passage;
a second supply flow passage capable of supplying the mixed fuel to the second fuel flow passage; and
a second valve which is disposed in the second supply flow passage, and which is configured to be capable of adjusting a flow rate of the mixed fuel to be supplied to the second fuel flow passage.

12. The combustion device according to claim 11, further comprising:
a heater capable of heating the mixed fuel produced by the mixer,
wherein the first supply flow passage is configured to supply the first fuel flow passage with the mixed fuel heated by the heater, and
wherein the second supply flow passage is configured to supply the second fuel flow passage with the mixed fuel heated by the heater.

13. The combustion device according to claim 11,
wherein the second valve is configured such that an opening degree of the second valve is adjustable in accordance with a mixing ratio of the first fuel and the second fuel in the mixed fuel.

14. A gas turbine, comprising:
a compressor for producing compressed air;
the combustion device according to claim 1, configured to generate combustion gas by combusting a fuel injected from at least one of the at least one first fuel injection hole or the at least one second fuel injection hole, with the compressed air from the compressor; and
a turbine configured to be driven by the combustion gas from the combustion device.
